(19) United States
(12) Patent Application Publication
(10) Pub. No.: US 2009/0024492 A1
(43) Pub. Date: Jan. 22, 2009

(54) Method and system for disk drive inventory

(76) Inventor: David S. Burgos, Laguna (PH)

Correspondence Address: HITACHI C/O WAGNER BLECHER LLP, 123 WESTRIDGE DRIVE, WATSONVILLE, CA, 95076, US

(21) Appl. No.: 11/880,279

(22) Filed: Jul. 19, 2007

(51) Int. Cl. G06F 17/00

(52) U.S. Cl. 705/28

(57) ABSTRACT

A post manufacturing inventory system to improve disk drive inventory after manufacturing are disclosed. One embodiment provides a computer system having serial number scanning capabilities to scan manufactured disk drive during a post manufacturing inventory count to reconcile with a drive count during manufacturing. In addition, a count verifier is coupled to the scanning unit to enable the inventory control system to verify real-time information read from the disk drives during inventory with pre-stored information pertaining to each drive.

### TECHNICAL FIELD

The present invention relates to the field of hard disk drive development and manufacturing, and more particularly to a method and system for controlling and maintaining inventory of hard disk drives in a manufacturing environment.

### BACKGROUND ART

Hard disk drives (HDD) are used in almost all computer system operations. In fact, most computing systems are not operational without some type of hard disk drive to store the most basic computing information such as the boot operation, the operating system, the applications, and the like. In general, the hard disk drive is a device which may or may not be removable, but without which the computing system will generally not operate.

The basic hard disk drive model includes a storage disk or hard disk that spins at a designed rotational speed. An actuator arm with a suspended slider is utilized to reach out over the disk. The slider is coupled with a suspension that supports both the body of the slider and a head assembly that has a magnetic read/write transducer or head or heads for reading/writing information to or from a location on the disk. The complete head assembly, e.g., the suspension, slider, and head, is called a head gimbal assembly (HGA).

In the course of manufacturing hard disks, various manufacturing protocols must be followed by operators. These manufacturing protocol may include tracking drives as they come off the assembly line to ensure that drives designated for specific customers or specific projects are properly monitored and inventoried. In the course of conducting inventory, disk drives from the assembly line, the manufacturing operators typically manually check unique identifiers, which may typically be bar-coded serial numbers, attached to each manufactured drive in order to track manufactured drives to keep count of the number of drives on the manufacturing floor during an inventory process.

Such manual check is fraught with errors, typically as a result of operator fatigue or the shear number of disk drives that have to be inventoried. The manual check can also be tedious, time consuming and unreliable. In order to avoid the inaccuracies in manually handling inventory on the assembly floor, operators typically perform double manual cross checks by either double checking inventory by the same operator or having different operators cross check the work of each other. Although such manual cross check and double check may reduce operator errors and inaccuracies, manual inventory of the disk drives in the manufacturing environment can still be time consuming and costly. Furthermore, the manual inventory checks is unable to account for missing drives in any meaningful manner.

### SUMMARY

In accordance with certain aspects of the present invention, manufactured disk drives in a manufacturing assembly floor are inventoried by using a combination of scanning tools and manual operator handling. One embodiment provides an inventory terminal or scanner for scanning identification information off individual disk drives which may be compared to a system database of declared serial numbers with associated information for identifying each disk drive during an inventory process. The information identifying each disk drive, the processes performed on each disk drive, the components of each disk drive may be stored in a predefined drive history database in a computer system.

In one embodiment, during inventory, blank scanners may be used to scan the hard disk drive serials numbers in a particular area. After scanning, the serial numbers from the scanners are downloaded to a computer and the scanned hard disk drive serial numbers of a particular process are compared to the list of downloaded hard disk drive serial numbers declared on a particular process by the system or data base. After comparing the hard disk drive serial numbers that are declared by the system or data base and not found from the scanned hard disk drive serial numbers, if a serial number is still not found the particular hard disk drive is declared as a discrepancy or a missing drive. These known missing hard disk drive serials will be downloaded to a scanner, then post scanning will be done to determine whether the missing drive may be found in a possible process area.

### BRIEF DESCRIPTION OF THE DRAWINGS

FIG. 1 is a plan view of an HDD with cover and top magnet removed with a serial identification label affixed to it in accordance with one embodiment of the present invention.

FIG. 2 is a schematic diagram of the overall inventory tracking system in accordance with one embodiment of the present invention.

FIG. 3 is a schematic diagram illustrating the movement of a hard disk drive through various processes on the manufacturing assembly floor n inventory control flow diagram, in accordance with one embodiment of the present invention.

FIG. 4 is a flow diagram for performing an inventory of hard disk drives on the assembly floor and detecting missing drives during the inventory process, in accordance with one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of a hard disk drive and components connected therewith. The discussion will then focus on embodiments of a method and system for conducting disk drive inventory in a disk drive assembly environment.

### Overview

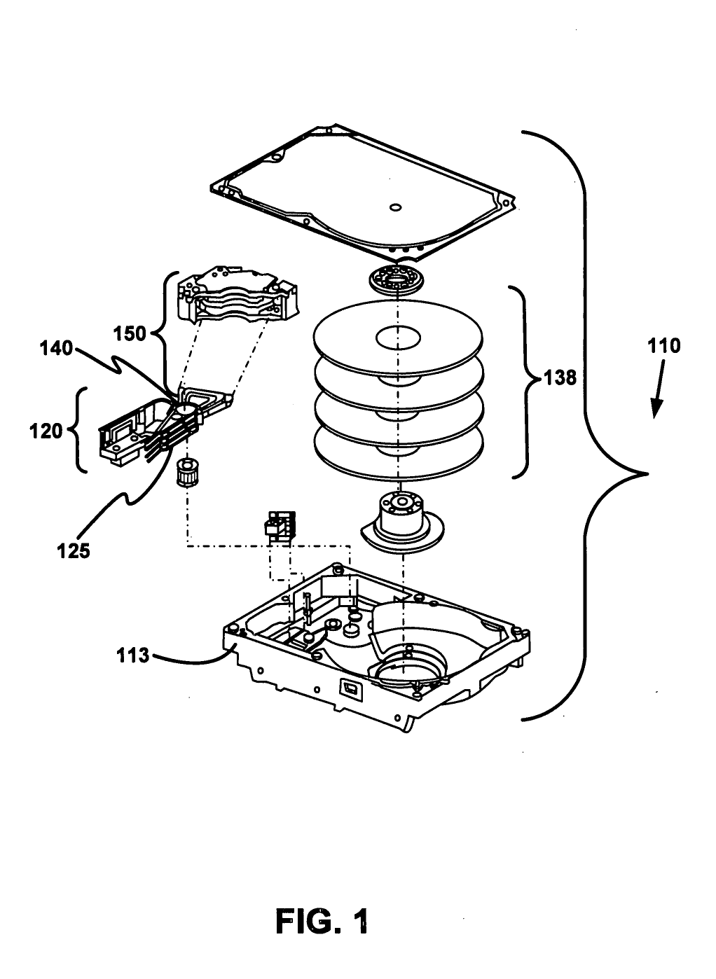

In general, the HDD comb (also referred to as an E-block) serves as a platform on which the suspensions (compliant members containing sliders with recording heads) are mounted. The recording heads fly at a constant height (on the order of nanometers) above the disk surface tracking pre-written servo information. An HDD carriage assembly (as shown in FIGS. 1A and 1B) forms the primary motive mechanical system that enables a disk-drive to randomly access data to be written or recorded on the disk surfaces.

With reference now to FIG. 1 a schematic drawing of one embodiment of an information storage system including a magnetic hard disk file or drive 110 for a computer system is shown. Hard disk drive 110 has an outer housing or base 113 containing a disk pack having at least one media or magnetic disk 138. The disk pack (as represented by disk 138) defines an axis of rotation and a radial direction relative to the axis in which the disk pack is rotatable.

A spindle motor assembly having a central drive hub 140 operates as this axis and rotates the disk 138 or disks of the disk pack in the radial direction relative to housing 113. An actuator 120 includes a plurality of parallel actuator arms 125 in the form of a comb that is movably or pivotally mounted to base/housing 113 about a pivot assembly 140. A controller 150 is also mounted to base 113 for selectively moving the comb of arms relative to the disk pack (as represented by disk 138).

In the embodiment shown in FIG. 1, each drive is affixed with an identification code, preferably a bar-coded label storing a unique serial number associated with the particular drive. The identification code could also include other information which an operator may be able to use to detect a drive in the manufacturing environment.

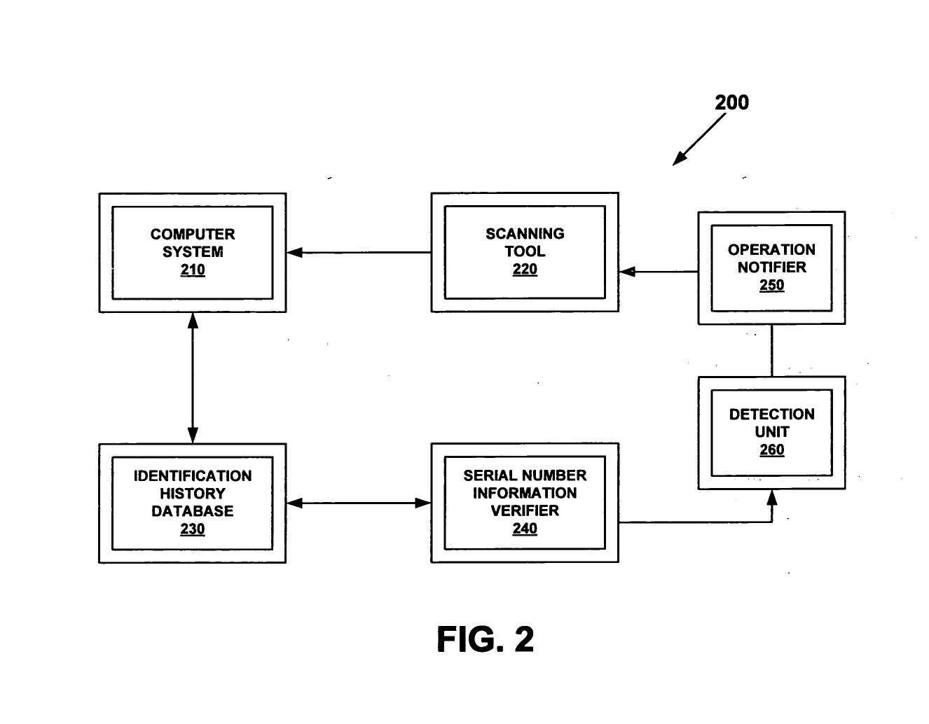

Referring now to FIG. 2 is a schematic diagram of the inventory monitoring system 200 in accordance with one embodiment of the present invention. In general, inventory monitoring system 200 includes a computer system 210, a scanning tool 220, a unique identification history database 230, an inventory verifier 240, an operator notifier 250 and a detection unit 260. The computer system 210 typically stores the unique identification history database 230 and the scanner 220 typically stores the operator notifier 250.

The inventory monitoring system 200 illustrated in FIG. 2 is an examples of a system which is capable of significantly improving hard disk drive inventory control on the drive manufacturing assembly floor. The system 200 is used to provide a systematic approach to track hard disk drives during an inventory process to reconcile real-time information gathered by an operator during the inventory process with the pre-stored unique identification information relating each drive manufactured in the unique identification history database 230.

In one embodiment of the present invention, the operator may manually scan the drives or the drives could be automatically scanned by the scanning tool 220. In one embodiment of the present invention, the identification information is affixed to each hard disk drive upon completion of manufacturing of the drive. In accordance with an embodiment of the present invention, the real-time scanned information is reconciled with the serial number data stored in the unique identification history database 230 to identify the presence of a particular drive.

The system database is an example of a computer database in which the computer system stores the system declarations corresponding to each serial number attached to a drive. In one embodiment, the system declarations include the location information of each drive at different processing locations on the assembly floor at a time prior to the inventory taking process.

In one embodiment of the present invention, during inventory, blank scanners may be used to scan the hard disk drive serials numbers in a particular area. After scanning, the serial numbers from the scanners are downloaded to a computer and the scanned hard disk drive serial numbers of a particular process are compared to the list of downloaded hard disk drive serial numbers declared on a particular process by the system or data base. After comparing the hard disk drive serial numbers that are declared by the system or data base and not found from the scanned hard disk drive serial numbers, if a serial number is still not found the particular hard disk drive is declared as a discrepancy or a missing drive. These known missing hard disk drive serials will be downloaded to a scanner, then post scanning will be done to determine whether the missing drive may be found in a possible process area

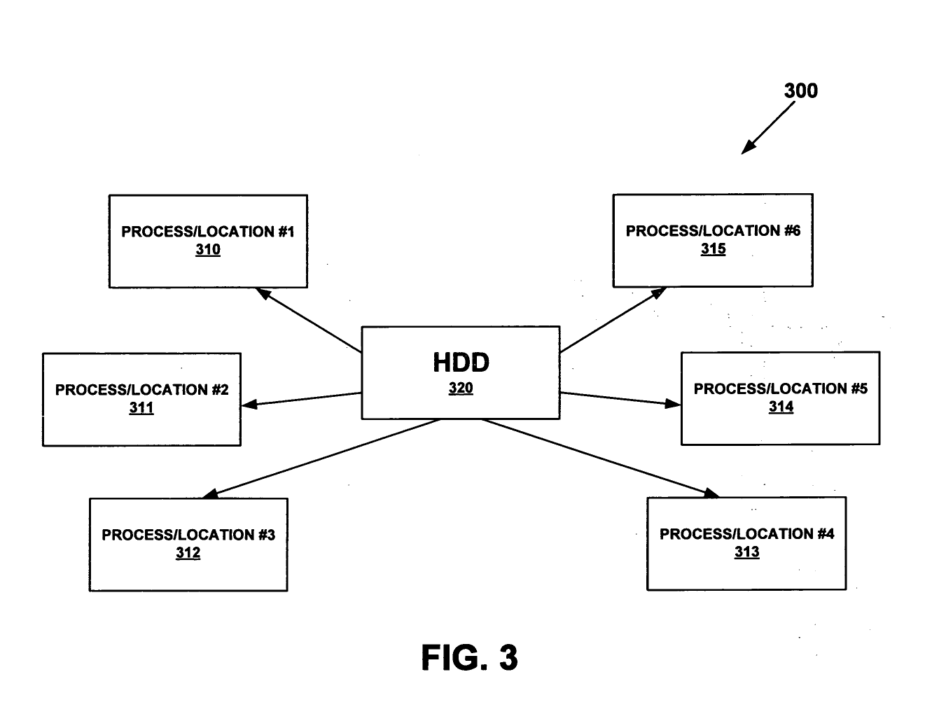

FIG. 3 is a schematic diagram of the movement of a disk drive through the assembly floor and the generation of the corresponding unique identification history database, in accordance with one embodiment of the present invention. In one embodiment, the movement of drive on the assembly floor enables an operator to manually create the serial number history by manually entering into the database the location information of the drive as the drive is moved from one location to another.

In one embodiment of the present invention, although a count of the disk drive is performed post manufacturing, a count is not performed as the disk drive is moved from location to location or from process to process. Therefore, during an inventory count, there is a strong potential for discrepancies between drive counted during inventory and what the system may have as manufactured.

In an alternative embodiment, the location or process could be automatically generated by scanning the drive as it arrives at each location or process and storing the location or process information corresponding to the drive in the serial number history database. The database creating process is preferably generated as a drive is moved to a location or as the drive is designated a location after the drive has been manufactured. The location or process history information allows the operator, during the inventory process, to account for all drives expected in a particular location.

The location information stored with the corresponding serial numbers are stored in the computer system and used to verify real-time information provided by the operator to the inventory computer system 200. In alternative implementations, additional or different types of information to track drives may be maintained. The illustrated location movement flow of the FIG. 3 shows certain events occurring during the manufacturing process in certain order which may be used as the identifying information for a particular drive.

In alternative embodiments, a drive may not be moved from one location to another but may have only one location information corresponding to its serial number. As the operator inventories drives in a particular location, drives that are detected to be in the wrong location are reconciled with the serial number database to determine whether the drive is missing or simply misplaced in the wrong location using any secondary information that may be stored in the unique identification history database.

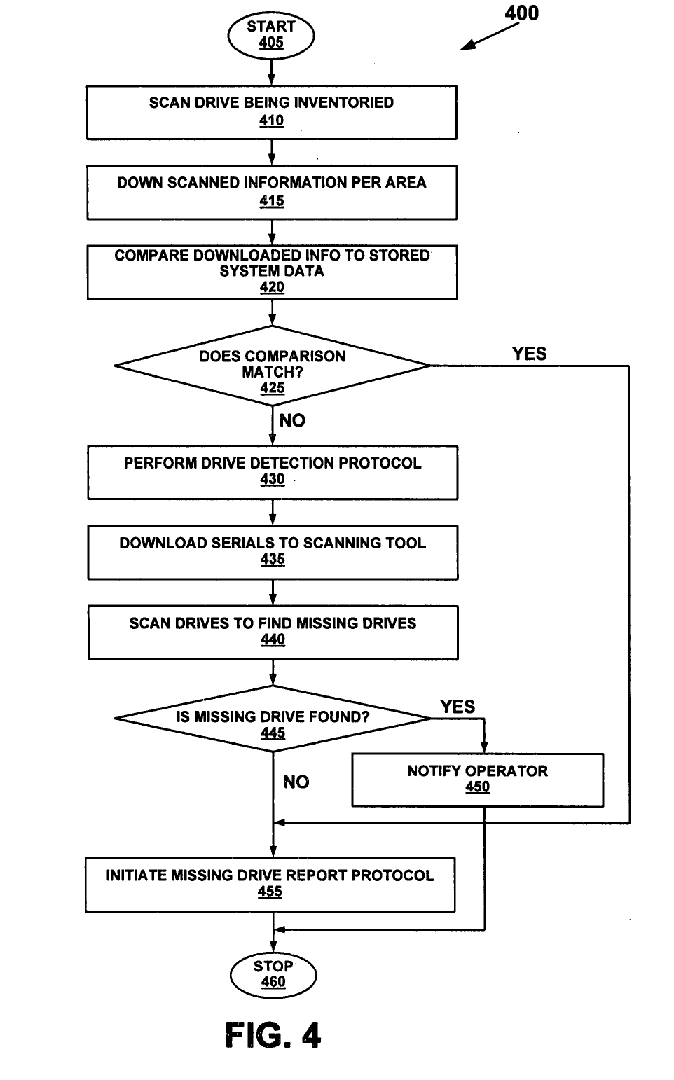

FIG. 4 is flow diagram of exemplary inventory operations 400 in accordance with one embodiment of the present invention. The inventory operation 400 illustrated in FIG. 4 may be utilized to verify the identity of each disk drive at any particular location on the assembly floor. In one embodiment of the present invention, the inventory operation 400 may be a computerized system similar to that illustrated in FIG. 2. Alternative, the inventory operation 400 may be performed by a combination of a system similar to the computerized system illustrated in FIG. 2 and a manual operation performed by an assembly floor operator.

To verify that disk drives have been properly sorted and assigned to the right assembly floor location, the scanning operations 400 is performed (block 405) on each drive to read the serial numbers inscribed or otherwise affixed to each drive (block 410). Using the scanned serial number information, relevant portions of the unique identification history database is looked-up to reconcile the scanned serial number with the stored location information to determine (block 420) whether the scanned drive is in the appropriately designated location.

The drive inventory information stored in the scanner could also be downloaded ( block 435) into the computer system to automatically verify whether the scanned information on drives in a particular location matches that stored in the computer system's drive inventory database. In one embodiment of the present invention, the downloaded scanned real-time drive inventory information, may be compared with the unique identification history database to reconcile the quantity of drives counted in a particular location. In one embodiment of the present invention, the scanned drive inventory information may be compared to the stored unique identification history database to verify drives scanned in a particular location to identify missing drives in that location.

If during (block 425) the comparison of the scanned information with the pre-stored system information, a drive is discovered to be missing or unidentifiable, a drive detection protocol (block 430) is performed. To perform the drive detection protocol, the pre-stored serial number of the drive generated during manufacturing prior to the inventory process is downloaded (block 435) into the scanning tool. The drives inventoried are scanned again (block 440) to determine whether (block 445) whether missing drives may be detected. If a missing drive is detected the operator is notified (block 450) and a retrieval operation could be undertaken to retrieve the drive to place it in the appropriate location. If the missing drive is not detected during the rescan, a missing drive protocol (block 455) is performed to generate a missing inventory report.

Following either the verification of the scanned drive information or the count of drives in a particular location, the operator could conduct a manual verification operation to identify any drives or corresponding serial number information that may be inappropriately placed in a particular location or missing from the assembly floor. Such manual operations enables the operator to institute further operating processes to prevent loss of drives from the assembly floor.

Thus, embodiments of the present invention provide a method and apparatus for utilizing an enhanced inventory control system to improve post manufacturing inventory in a disk drive manufacturing environment.

Furthermore, a reduced inventory process time is realized. That is, because the using the present invention enhances the interaction between a computerized inventory system and an manufacturing operator in a way that reduces the fatigue involved in taking post manufacturing inventory.

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for conducting post manufacturing inventory of hard disk drive, comprising:
generating a database of serial numbers uniquely identifying each disk drive manufactured during a pre-inventory manufacturing cycle; and
affixing labels corresponding to said serial numbers to each of said disk drive;
scanning said labels during an inventory count process to count the number of disk drives during said post manufacturing inventory;
comparing the scanned disk drive count with the database of serial numbers to reconcile the count of serial numbers with the count of the disk drives.

2. The method of claim 1, wherein the generating of the database of uniquely identifying serial numbers keeps a count of disk drives manufactured prior to the inventory count process.

3. The method of claim 1, further comprising:
conducting a post inventory verification count if there is a mismatch between the scanned count of the disk drives and the count of serial numbers in the serial number database.

4. The method of claim 3, wherein verifying the inventory count comprises downloading serial numbers present in the serial number database and not found during the inventory count into the scanning tool to perform a post inventory verification process.

5. The method of claim 4, wherein the post inventory verification process comprises rescanning the disk drives scanned during the inventory count process comprising notifying an operator performing the post inventory verification:

6. The method of claim 5, wherein if a disk drive undetected during the inventory count process is discovered during the post inventory verification, a recognizable alert notification from the scanner to an operator conducting the inventory is sent to enable the operator reconcile the inventory count.

7. The method of claim 6, wherein if a missing disk drive is undiscovered during the post inventory verification an inventory incident process is initiated to generate a missing inventory report.

8. The method of claim 7, wherein the post manufacturing inventory count is performed in real-time.

9. A hard disk drive post manufacturing inventory control system, comprising:
a computer system storing a database of pre-inventory serial numbers corresponding to each hard disk drive manufactured during a pre-inventory manufacturing cycle;
a scanning tool for reading unique identification information affixed to each of said hard disk drives manufactured during the pre-inventory manufacturing cycle, said unique identification information corresponding to said serial numbers;
a verification unit for verifying inventory count of the hard disk drives during a post manufacturing inventory count with a count of serial numbers in the database of pre-inventory serial numbers; and
a detection unit for detecting any discrepancies between the pre-inventory count of the disk drives and the post manufacturing inventory count of the disk drives.

10. The hard disk drive post manufacturing inventory control system of claim 9, further comprising an operator notification unit for notifying an operator conducting the post manufacturing inventory count when a missing hard disk drive is found.

11. The hard disk drive post manufacturing inventory control system of claim 10, wherein the notification unit is coupled to the scanning tool.

12. The hard disk drive post manufacturing inventory control system of claim 11, wherein the unique identification information of each of the hard disk drives may be inscribed on a cover of each of the hard disk drives.

13. The hard disk drive post manufacturing inventory control system of claim 12, wherein the scanning unit is a computerized scanning system.

14. The hard disk drive post manufacturing inventory control system of claim 13, wherein the scanning unit is a programmable handheld scanner.

15. The hard disk drive post manufacturing inventory control system of claim 14, wherein an inventory report is generated when the verification unit is unable to find a missing hard disk drive during the post manufacturing inventory count.
